(19) United States
(12) Patent Application Publication
(10) Pub. No.: US 2008/0244039 A1
(43) Pub. Date: Oct. 2, 2008

(54) METHOD OF VIRTUAL ONLINE STORAGE OF DOCUMENTS WITH A USER FRIENDLY INTERFACE

(76) Inventor: RUSS WERTZ, Irvine, CA (US)

Correspondence Address: CHARLES C.H. WU, 98 DISCOVERY, IRVINE, CA, 92618-3105, US

(21) Appl. No.: 11/690,109

(22) Filed: Mar. 22, 2007

(51) Int. Cl. G06F 15/16; G06F 15/00; H04L 9/32; G06F 21/00; G06F 17/30

(52) U.S. Cl. 709/219; 726/28; 726/6; 707/101; 707/9; 707/E17.059; 707/E17.006

(57) ABSTRACT

This invention relates to a method for providing a superior file storage system which utilizes the Internet and which has security as well as a superior user experience as foremost goals. The invention is ideal for the secure storage of critical documents, combining the security of a safe deposit box with the advantages of online file storage. Furthermore, the invention is designed to minimize time spent by an end user on organization, security, and file format issues.

### BACKGROUND OF INVENTION

1. Field of the Invention

The present invention, in general, relates to a method for storing and securing critical documents. More particularly, this invention pertains to a method of storing critical documents in an online storage system similar to an online “safe deposit box,” and providing access to said documents over the Internet through a user-friendly and secure interface.

2. Description of the Related Art

Consumers have long had to maintain important documents in a secure fashion. However, maintaining paper copies of strategic documents can be difficult; paper copies can easily be destroyed, misplaced, lost, stolen, misfiled, or mishandled. This problem has especially troubled married couples, where it is frequently the case that documents can not be located when a spouse passes away without informing their partner as to the location of various sensitive documents.

Methods for third parties to store documents onto the Internet are known. For example, U.S. Pat. No. 6,351,776 to O'Brien et al. (the “O'Brien patent”) describes a file storage and retrieval system available worldwide via the Internet, acting in the manner of an Internet “hard disk” or Internet “hard drive.” However, the O'Brien patent requires the end user to install proprietary software onto their computer hardware in order to use this service. This can be burdensome for an end user, or require technical expertise which some end users might lack. For example, an end user who frequently travels may not always have the option of installing software onto a computer.

U.S. Pat. No. 7,136,903 to Phillips et al. (the “Phillips patent”) also describes an online file storage service and system; however, said system is specifically designed to enable numerous users to access a group of files simultaneously. The Phillips patent thus does not describe a method suitable for a single user seeking a secured account which only the end user can access.

Furthermore, both of the inventions described by the foregoing two patents allow the end user a direct means to upload and delete files from an account. This has significant disadvantages when an end user's goal is to secure documents; for example, it allows unauthorized intruders into the account to delete potentially important documents, or for same to be deleted through inadvertent human error.

In addition, both the O'Brien patent and Phillips patent require that the end user have the documents they wish to store online in an online format before using the described method(s). Many users receive documents in a paper copy format only. Furthermore, both patents require the end user to spend time designing an organization structure for documents. In addition to being burdensome and time-consuming, many end users simply lack the organization skills to create an adequate filing scheme.

Accordingly, a need arises for a superior file storage system which utilizes the Internet and which has security as well as a superior user experience as foremost goals.

### SUMMARY OF THE INVENTION

This invention relates to a method of creating an online safe harbor for strategic documents so that end users can store documents in an organized and secure way. This is made possible by an Internet website, sections of which are protected by security measures that provide and limit access to documents to the end user.

A benefit of the invention is to provide an equivalent to a safe deposit box in terms of security, but one that is available twenty-four hours a day, regardless of the end user's geographical location.

Another benefit of the invention is the user-friendly interface which allows users without technical expertise to use the invention using only a standard Internet browser (e.g. Mozilla Firefox, Internet Explorer, Netscape Navigator). This is as opposed to requiring an end user to install proprietary software onto a computer in order to use an account.

Another benefit of the invention is that an organization scheme is provided to the end user, instead of requiring the end user to devise an organizational scheme on their own time and initiative. Furthermore, documents received from an end user are placed in an appropriate place within the organizational scheme, further lessening the organizational burdens on the end user, as well as eliminating the risk that documents will be mis-filed by the end user.

Another benefit of the invention is that it allows end users to delegate security responsibilities. Most end users lack the expertise or time to stay current with the latest developments in security and security technologies.

Another benefit of the invention is that it only allows documents to be deleted upon oral or written request, and does not automate the choice to delete documents. This greatly reduces the risk that important documents will be destroyed by user error or the malice of third party intruders to the system.

A further benefit of the invention is it provides end users with a means of sharing documents with third parties, without overly sacrificing security. Instead of requiring end users to provide complete access to an account to third parties when an end user desires to share a single document, in the present invention end users can simply send e-mails to third parties that provide links to webpages created specifically for the limited distribution of specific documents, which webpages are then destroyed after a brief period of time in order to maximize security.

Many end users possess critical documents that are only on paper (or a similar tangible medium). These end users might lack the time to create virtual copies of their critical documents, or lack the equipment to create virtual copies of critical documents. Thus, a further benefit of the present invention is to convert such documents to a computer format for the end user's benefit.

These and other features of the present invention will become apparent from the following Description of Preferred Embodiments when taken in conjunction with the claims and drawing figures herein described.

### BRIEF DESCRIPTION OF THE DRAWINGS

FIG. 1 presents a flowchart to illustrate the steps taken to create an account and house documents within the account.

FIG. 2 presents a flowchart to illustrate the steps taken to communicate with an end user who has an account.

FIG. 3 presents an embodiment of an organization structure utilized by a preferred embodiment of the present invention.

FIG. 4 presents an embodiment of an organization structure utilized by a preferred embodiment of the present invention.

FIG. 5 presents an embodiment of an organization structure utilized by a preferred embodiment of the present invention.

FIG. 6 presents an embodiment of an organization structure utilized by a preferred embodiment of the present invention.

### DESCRIPTION OF THE PREFERRED EMBODIMENTS

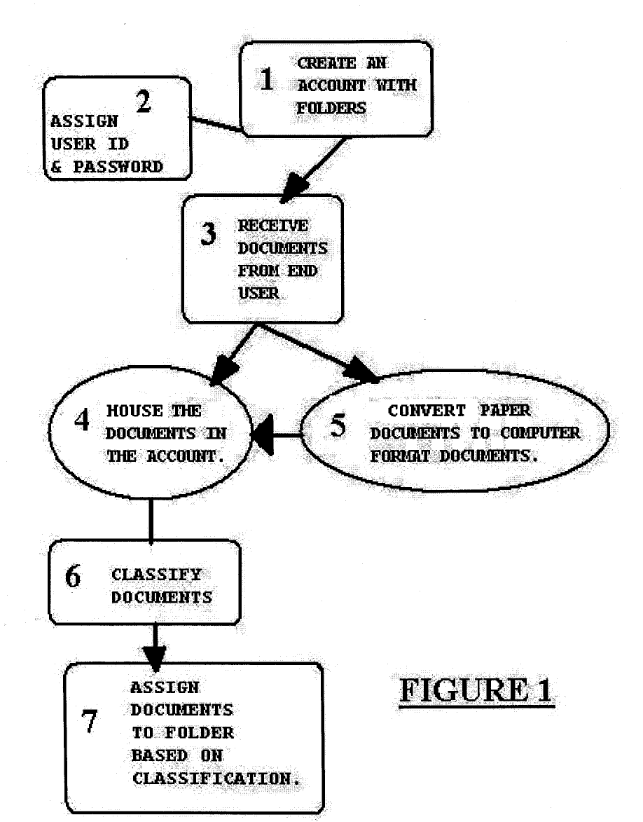

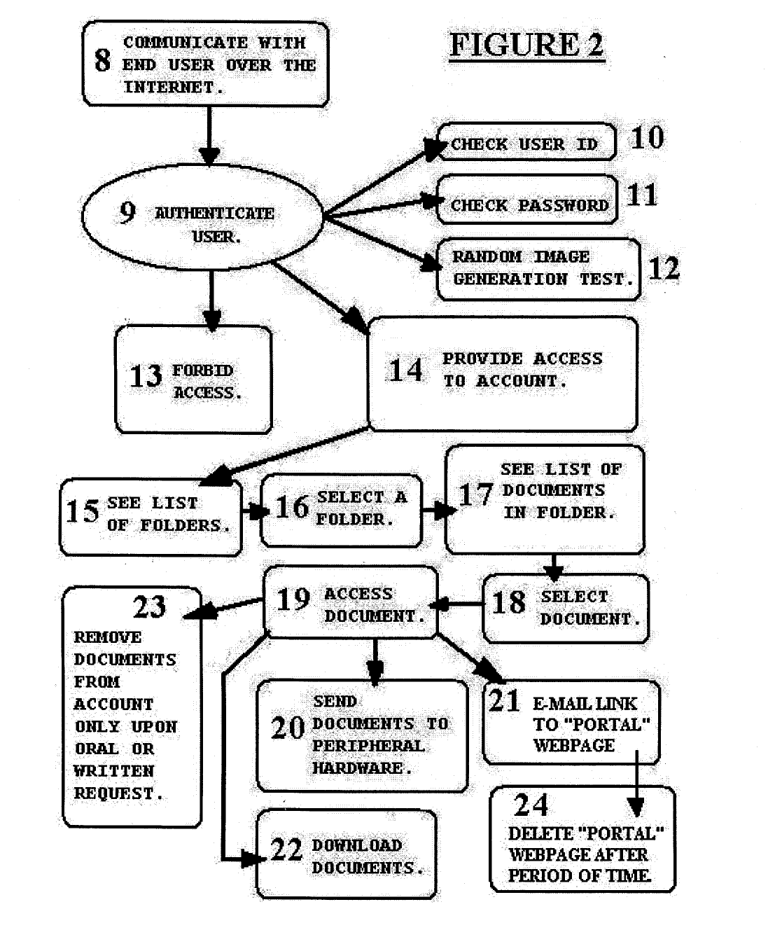

FIGS. 1 and 2 are flowcharts describing steps of the preferred embodiment of the present invention. Although the steps are shown in a serial fashion for ease of explanation, there is no sequential limitation implied other than indicated in the appended claims. In addition, some steps may be optional.

Referring to FIG. 1, an account is created 1 on a local computer. This account has a filing scheme comprising of folders which folders may or may not contain sub-folders, which sub-folders themselves may or may not contain sub-folders, and so on.

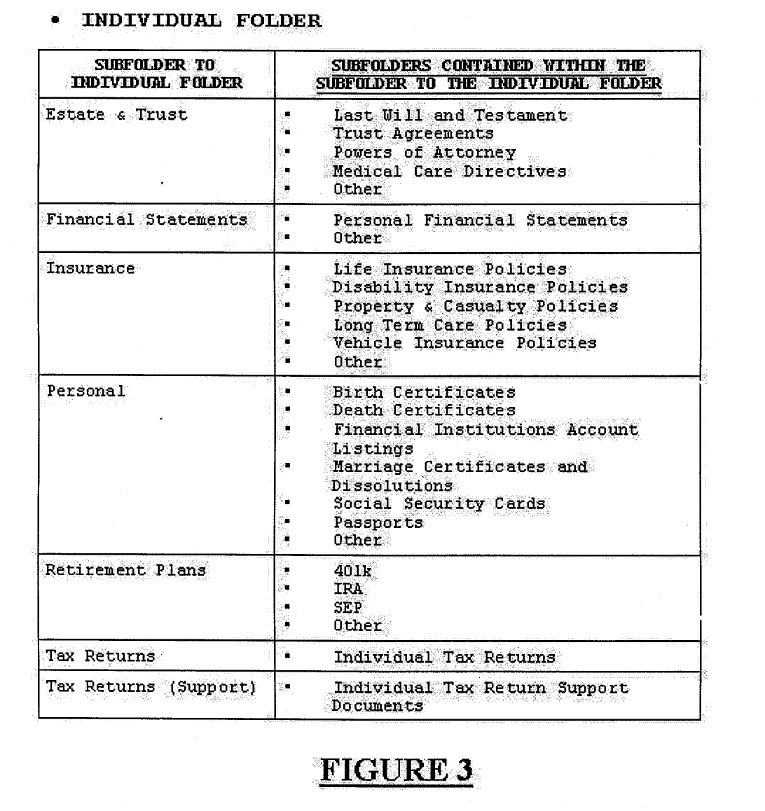

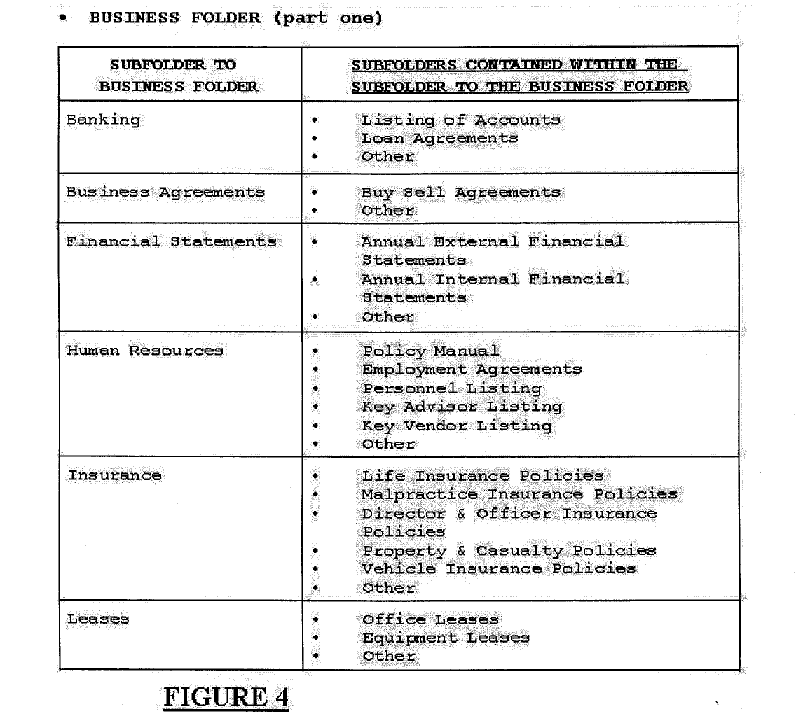

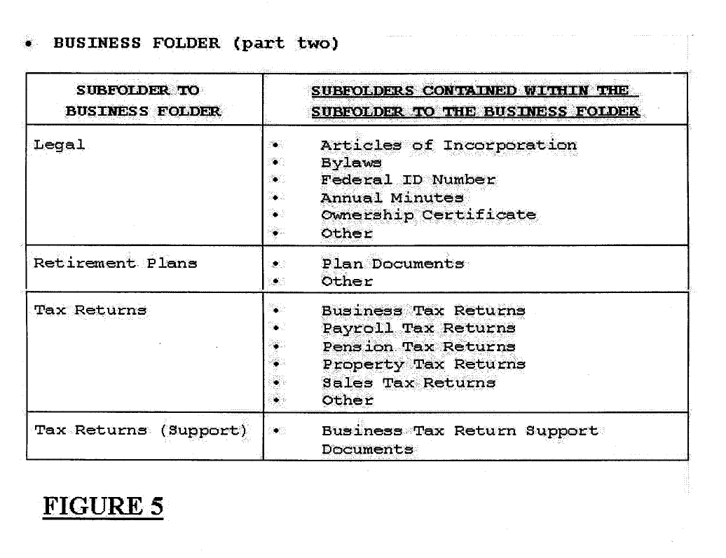

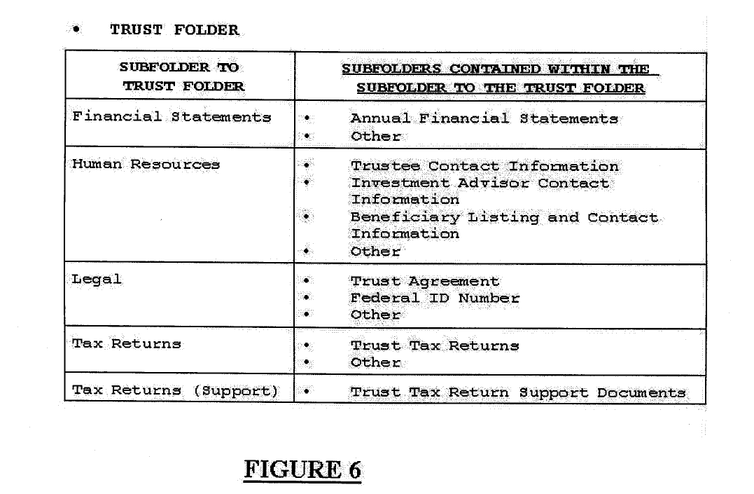

In the preferred embodiment, there are three folders—an “Individual” or “Individual Box” folder, a “Business” or “Business Box” folder, and a “Trust” or “Trust Box” folder. Each of these folder contains numerous sub-folders (which themselves contain sub-folders). An example of this embodiment is illustrated on FIGS. 3, 4 and 5; FIG. 3 illustrates an example of the organizational hierarchy of the Individual Folder, FIGS. 4 and 5 illustrate the organizational hierarchy of the Business folder, and FIG. 6 illustrates an example of the organizational hierarchy of the Trust folder.

Furthermore, in the preferred embodiment, upon creating the account, a user identification or “User ID” and password are assigned 2 to the end user for security purposes. The end user may be able to pick his or her own User ID and password.

Having created 1 an account with a filing structure as set forth hereinabove, documents from the client are received 3 from the end user. Oftentimes, these documents may have been received prior to the creation of the account. The documents might be in an acceptable computer format (e.g., PDF, JPEG, TIFF), but the preferred embodiment of the present invention, unlike the prior art, will also accept documents on paper and convert 5 said paper documents to an acceptable computer format. This can be accomplished by, inter alia, a scanner or a digital camera. The term “paper” herein means any hard copy of the document or copy of the document capable of being read using only the naked eye.

The documents are then housed 4 in the account. While an end user may have some input on where a document is housed, in the preferred embodiment, the document will be classified 6 based upon its content and then assigned 7 to a folder and sub-folder accordingly.

Using the above-referenced folder scheme illustrated on FIGS. 3-6 as an example of the foregoing, the end user might provide 3 a passport, which will then be scanned 5 in, identified 6 as a passport, and then assigned 7 to the appropriate sub-folder: the “Passport” sub-folder to the “Personal” Sub-folder of the “Individual” folder (See FIG. 3). Providing a pre-constructed file structure for the end user is an improvement upon the prior art: the prior art forces end users to be solely responsible for organizing large numbers of complicated strategic documents; providing a pre-existing framework for an end user will save time for the end-user both in creating an organization structure and in later locating documents within that structure.

Referring to FIG. 2, once an account has been created, a user friendly Internet website provides the user with access to the sensitive documents. This is an improvement upon the prior art because it avoids requiring that an end user place any proprietary software on their computer to access documents, other than a standard web browser. Furthermore, it requires less technical savvy for the end user to gain the benefit of the present invention.

The end user using a web browser communicates 8 with an embodiment of the present invention over the Internet via a series of internet webpages configured to provide a range of options concerning access to the strategic documents. In the interest of maintaining strict security upon the account, the end user's identity is first authenticated 9 by a security protocol. This security protocol may include, but is not limited to, an encrypted password, a TLS or SSL certificate for secure log in sessions, and random image password generation for secure login access.

In the preferred embodiment, as stated above, a User ID and password had been assigned 2 to the end user at the time the account was created. When the end user attempts to access the account (or “login” to the account), an end user is asked by one of the webpages to input said user identification or “User ID” 21 and said password 22. The inputted User ID 21 and password 22 are checked against the User ID and password previously assigned 2 to the end user. If there is a match, a randomly generated set of characters are displayed on the end user's monitor, and the end user is asked to correctly input 12 said random set of characters. This latter test prevents automated software from performing actions which degrade the quality of service; for example, it prevent “robot”-type software-driven logins that are typical of internet “spam” or intruders. This random-image system is also known as a CAPTCHA (“Completely Automated Public Turing test to tell Computers and Humans Apart”) challenge-response test. In the preferred embodiment, a TLS (Transport-Layer Security) “certificate” or SSL (Secure Sockets Layer) “certificate” is used to preserve the security of the above-described “login” by the end user; said certificates involve cryptographic protocols which protect against several well-known attacks frequently used by third-party intruders.

In said preferred embodiment, if the end user has inputted the correct user ID 10 and password 11, and has satisfied said random image generation test 12, the end user is authenticated. If the user's identity can not be authenticated, further access is not allowed 13 by the system.

For users whose identities are authenticated, access to the account is provided 14. Access to the account includes but is not limited to allowing the end user to see a list of folders 15, select a folder 16, and to see the contents of the folder (i.e. which documents are housed in a particular folder or sub-folder) 17. This allows an end user to navigate through the filing structure of the account in order to locate and selectively view documents of a particular type or category. In FIG. 2, these might be indicated to be steps in a series, but there is no sequential limitation implied other than indicated in the appended claims.

The authenticated end user can select documents 18 and choose to access said selected document 19. In the preferred embodiment, access includes allowing an end user to download the selected document to his own computer 22, or to send the documents to peripheral hardware which the end user has attached to their computer 20. The classic example of peripheral hardware is a printer.

In the preferred embodiment, access also includes an “e-mail” option 21. If chosen by the end user, the “e-mail” option prompts the end user to input an e-mail address. An e-mail is sent to that address which contains a link to a “portal” webpage. The “portal” webpage is a webpage which provides limited access only to the selected document. The recipient of the e-mail clicks on the link in the e-mail and is taken to the “portal” webpage, where the recipient is allowed to view the selected document (but not other documents contained in the account), send the document to a peripheral device of the recipient such as a printer, or to download the document. For security purposes, this “portal” webpage is only available to the recipient for a limited period of time, after which time it is deleted 24. In the preferred embodiment, the “portal” webpage is removed from the system after seventy-two (72) hours (i.e. three days). This “portal” webpage system is an improvement upon the prior art because it allows an end user to selectively share a document without surrendering control over either the document or the account.

A decision to delete 23 a document requires a written or an oral request. This is an improvement upon the prior art because (a) it prevents third parties who might illegally intrude into the system from destroying strategic documents, and (b) it prevents strategic documents from being destroyed by human error on the part of the end user.

Other embodiments of the invention will appear to those skilled in the art from consideration of the specification and practice of the invention disclosed herein. A possible application of the present invention includes, but is not limited to, an online “safe deposit box” for strategic financial documents. It is intended that the specification and examples be considered as exemplary only, with a true scope and spirit of the invention being indicated by the following claims.

What is claimed is:

1. A method for storing documents of an end user online, said method comprising,
establishing an account on a local computer for an end user;
receiving a document from the end user;
housing the document in a computer format in the account;
communicating over the Internet with a remote computer used by the end user through a series of webpages viewable using a standard Internet web browser;
testing whether the end user can confirm his identity;
preventing an end user who can not confirm his identity from accessing the account;
for an end user who can confirm his identity, providing at least one webpage to the end user over the Internet that allows the end user to select one of the documents housed in the account;
for the document that was selected, allowing the end user to access said document; and
removing a document from the account only upon a request from the end user communicated orally or in writing.

2. The method as recited in claim 1, wherein the step of receiving a document from the end user further comprises converting a document contained on a medium not capable of being housed on a computer, to a computer format that allows the document to be housed on a computer.

3. The method as recited in claim 1 wherein the step of establishing an account on a local computer further comprises creating a organizational structure of folders and sub-folders.

4. The method as recited in claim 3 wherein the step of housing the document in a computer format in the account, further comprises:
classifying the documents received from the end user;
choosing a corresponding folder and a corresponding subfolder of the organizational structure in which to place the documents, based upon said classifying; and
placing the document in the corresponding folder and corresponding subfolder.

5. The method as recited in claim 3 further comprising the step of, for an end user who can confirm his identity, allowing the end user to navigate through the organizational structure such that the end user can selectively see which subfolders are contained within a folder, and can view which documents are housed in a folder or subfolder selected by the end user, from which viewing the end user can choose which document to select.

6. The method as recited in claim 3, wherein said organizational structure of folders and sub-folders is comprised of an Individual Folder, a Business Folder, and a Trust Folder.

7. The method as recited in claim 6, wherein said Individual Folder contains an Estate & Trust sub-folder, a Financial Statements sub-folder, an Insurance sub-folder, a Personal sub-folder, a Retirement Plans sub-folder, a Tax Returns sub-folder, and a Tax Returns (Support) sub-folder.

8. The method as recited in claim 6, wherein said Business Folder contains a Banking sub-folder, a Business Agreements sub-folder, a Financial Statements sub-folder, a Human Resources sub-folder, an Insurance sub-folder, and a Leases sub-folder.

9. The method as recited in claim 6, wherein said Trust Folder contains a Legal sub-folder, a Retirement Plans sub-folder, a Tax Returns sub-folder, and a Tax Returns (Support) sub-folder.

10. The claims as recited in claim 7, wherein each of said sub-folders themselves contain a number of unique sub-folders.

11. The claims as recited in claim 8, wherein each of said sub-folders themselves contain a number of unique sub-folders.

12. The claims as recited in claim 9, wherein each of said sub-folders themselves contain a number of unique sub-folders.

13. The method as recited in claim 1 where the step of testing whether the end user can confirm his identity comprises:
generating a random set of characters;
communicating the random set to the end user; and
asking the end user to correctly input the random set;
wherein the end user's identity is confirmed if the end user can correctly input the random set.

14. The method as recited in claim 1, the step of establishing an account further comprising assigning a assigning a unique user identification and password to the account.

15. The method as recited in claim 12 where the step of testing whether the end user can confirm his identity comprises providing a website to the end user that asks the end user to correctly input the unique user identification and the password previously assigned to the account;
wherein the end user's identity is confirmed if the end user can correctly input the unique user identification and password.

16. The method as recited in claim 1, wherein the step of allowing the end user to access a document comprises allowing the end user to choose to download a copy of said document from the local computer to the remote computer.

17. The method as recited in claim 1, wherein the step of allowing the end user to access a document comprises allowing the end user to choose to send said document from the local computer to a peripheral hardware device attached to the remote computer.

18. The method as recited in claim 1, wherein the step of allowing the end user to access a document comprises allowing the end user to choose to send an e-mail to an e-mail account inputted by the end user, which e-mail includes a link to a limited webpage, which limited webpage is configured to allow a recipient of the e-mail to choose to download a copy of said document to the recipient's computer, which limited webpage is further configured to allow the recipient to choose to send said document from the local computer to a peripheral hardware device attached to the recipient's computer.

19. The method as recited in claim 16 where the limited webpage is destroyed after a limited period of time, after which limited period of time the recipient no longer can access said document by using the link contained in said e-mail.
